(19) United States
(12) Patent Application Publication
(10) Pub. No.: US 2011/0127691 A1
(43) Pub. Date: Jun. 2, 2011

(54) FACTORY FOR THE MOLDING MANUFACTURE OF PRECAST CONCRETE VOUSSOIRS FOR THE CONSTRUCTION OF WIND GENERATOR SUPPORT TOWERS

(75) Inventors: Miguel Ángel Fernández Gómez, Madrid (ES); José Emilio Jimeno Chueca, Madrid (ES)

(73) Assignee: INNEO TORRES S.L., Madrid (ES)

(21) Appl. No.: 12/956,175

(22) Filed: Nov. 30, 2010

(30) Foreign Application Priority Data
Nov. 30, 2009 (ES) P200902259

(51) Int. Cl. B28B 5/04

(52) U.S. Cl. 264/228; 425/63

(57) ABSTRACT

A factory for the molding manufacture of precast concrete voussoirs for the construction of wind generator support towers, the concrete voussoirs manufactured by molding in said factory, and a wind generator support tower at least partially constructed by concrete voussoirs manufactured by molding in said factory, as well as to the operating method of said factory.

REFERENCE TO RELATED APPLICATION

This application claims priority to Spanish patent application No. P200902259, filed Nov. 30, 2009, the disclosure of which is incorporated herein by reference.

### FIELD OF THE INVENTION

The present invention relates to a factory for the molding manufacture of precast concrete voussoirs (wedge-shaped panels) for the construction of wind generator support towers, to the concrete voussoirs manufactured by molding in said factory, and to a wind generator support tower at least partially constructed by concrete voussoirs manufactured by molding in said factory, as well as to the operating method of said factory.

### BACKGROUND OF THE INVENTION

Making at least one portion of wind generator towers using precast concrete voussoirs instead of metal parts has been known for a relatively short time.

This practice enables obtaining wind generator support towers with better mechanical strength properties. However, for practical design reasons, at least some of the precast concrete voussoirs intended for the construction of wind generator support towers must be extraordinarily large and heavy.

Due to the relative newness of the practice of using precast concrete voussoirs instead of metal parts for making at least one portion of wind generator towers as was previously mentioned, there are virtually no factories dedicated to the manufacture of parts of this type. In the state of the art there are, however, large precast facilities which do not manufacture parts of this type but rather others with their own characteristics but they are potentially capable of manufacturing parts of this type with the pertinent adjustments. These large facilities include large load capacity gantry cranes or bridge cranes extending substantially along the entire production line, first handling raw material and then precast parts to a stocking area in which are stored said parts. Said gantry cranes or bridge cranes are supported, as a last resort, on foundations of either the support columns of the roof of the facility in the case of bridge cranes or on their own support columns in the case of gantry cranes.

Therefore, the state of the art in the field of the invention generally presents large and expensive facilities which are essentially immobile in the sense that they are built with a view to a permanent site, so in addition to the fact that building and dismantling them can be equally expensive and tedious, building them causes structural changes in the location terrain that are extremely difficult if not impossible to reverse, even after being dismantled, i.e., they have a substantial environmental impact.

Furthermore, if the parts were precast concrete voussoirs for making at least some of the wind generator towers, once the voussoirs are precast in the facility, clear drawbacks would arise in terms of handling large and heavy voussoirs.

For example, the road transport of large voussoirs from the facility to the point of erection of the pertinent towers, in addition to involving an elevated cost, is an always complicated task with certain risks, entailing a problem especially in territories with very strict regulations concerning the road transport of large-sized parts. By way of example, in Spain, in particular, transporting voussoirs of more than 20 meters in length involves a number of additional legal requirements so in practice, manufacturers normally limit the longitudinal dimension of the voussoirs they produce precisely to said length of 20 meters. Likewise, in practice manufacturers usually limit the transverse dimension of the voussoirs they manufacture to a width of 5 meters for similar reasons. Additionally, those complications are accentuated because they are heavy items.

In other countries, the regulation can be even more restrictive and limit the dimensions of the voussoirs to smaller sizes or require more permits and authorizations. Obviously, in addition to regulatory and permit issues, in less developed countries with less advanced road systems practical transport problems can arise which could even be insurmountable.

Therefore, there is a need to improve the system of molding manufacture of precast concrete voussoirs intended for the construction of wind generator support towers such that the drawbacks derived from handling the manufactured voussoirs even in the event that they are large, precisely without limiting the size or the weight of the voussoirs to be manufactured and limiting the environmental impacts, are reduced.

### SUMMARY OF THE INVENTION

The object of the present invention is, therefore, a factory for the molding manufacture of precast concrete voussoirs intended for the construction of wind generator support towers enabling the reduction of the drawbacks derived from handling the manufactured voussoirs even in the event that they are large and heavy, without precisely limiting neither the size nor the weight of the voussoirs to be manufactured and limiting the environmental impacts.

More specifically, a first aspect of the present invention is a factory for the molding manufacture of precast concrete voussoirs intended for the construction of wind generator support towers, using passive steel or rebar-like elements, as well as active pre-stressing steel, with or without sheath, concrete and finishing accessories, the factory including hoisting means and concreting means, the factory also including:
at least one reinforcing station, with at least one frame, for preparing cores of rebar-like elements called cages,
at least one concreting station, with at least one mold including a main mold body, a counter mold and a protective canvas for the steam setting, for the application of one of said cages in said mold, the concreting of said mold, the setting of said concrete in said mold and the extraction of the set part (semi-finished voussoir) from said mold,
at least one conditioning station for the finishing of said semi-finished voussoir and/or the application of finishing accessories to said semi-finished voussoir, and
at least one stocking area for the storage of finished voussoirs;

wherein the base of said reinforcing station, said concreting station and said conditioning station comprises a concrete slab formed directly on compacted terrain, i.e., without foundations, anchors or the like to the compacted terrain, said hoisting means are hoisting means without foundations, said mold body is divided into at least two portions attached to one another by fixing means, and said counter mold is divided into at least two portions attached to one another by fixing means.

A factory is thus provided for the molding manufacture of precast concrete voussoirs intended for the construction of wind generator support towers, having structural features which allow placing the factory in a place of origin in a disassembled state in initial units that are smaller than the voussoirs to be manufactured, taking said initial units to a building site close to the point of delivery or assembly of the voussoirs to be manufactured, assembling the factory at said building site starting from said initial units, manufacturing the pertinent voussoirs by means of the factory in the assembled state, disassembling the factory at said building site until the factory is in a disassembled state in final units that are smaller than the manufactured voussoirs, and taking said final units to a place of destination, leaving said building site in basically the same conditions as before the assembly of the factory at said building site, i.e., with an essentially nil environmental impact.

Said place of destination can logically be said place of origin from the start, or it can be a different building site.

The manufacture can thus take place at a building site that is so close to the point of delivery or assembly of the voussoirs that the drawbacks derived from handling said voussoirs even in the case of them being large and heavy are considerably reduced.

In fact, the manufacture can take place at a building site that is so close to the point of delivery or assembly of the voussoirs that road transport is avoided, as are the aforementioned drawbacks, the dimensions of the voussoirs to be manufactured then being limited by the load capacity of the hoisting means, which is usually greater than the road transport means which are typically used in the state of the art.

Additionally, the factory can include (pre-tensioned reinforcement and/or post-tensioned reinforcement) pre-stressing performance means, which will preferably be arranged in said concreting station or in said conditioning station.

Optionally, all or part of the hoisting means without foundations and/or the concreting means can be mobile. For example, the hoisting means can comprise one or more boom crane trucks or one or more gantries on wheels (optionally self-propelled) and/or the concreting means can comprise one or more concrete mixer trucks or one or more pieces of concrete distribution equipment, including pumping equipment.

Preferably, said concrete slab is formed on site in a single part.

In any case, the concrete slab will preferably have a thickness of 15 cm at the least and preferably of 25 cm at the most.

A second aspect of the present invention is a concrete voussoir intended for the construction of wind generator support towers, manufactured in said factory.

Finally, a third aspect of the present invention is a wind generator support tower at least partially constructed by concrete voussoirs manufactured in said factory.

Various other objects, advantages and features of the present invention will become readily apparent to those of ordinary skill in the art, and the novel features will be particularly pointed out in the appended claims.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 schematically shows the layout of a first embodiment of a factory for the molding manufacture of precast concrete voussoirs intended for the construction of wind generator support towers according to the present invention;

FIG. 2 schematically shows a front view of FIG. 1;

FIG. 3 schematically shows the layout of a second embodiment of a factory for the molding manufacture of precast concrete voussoirs intended for the construction of wind generator support towers according to the present invention; and

FIG. 4 schematically shows a front view of FIG. 3.

### DETAILED DESCRIPTION OF THE PRESENT INVENTION

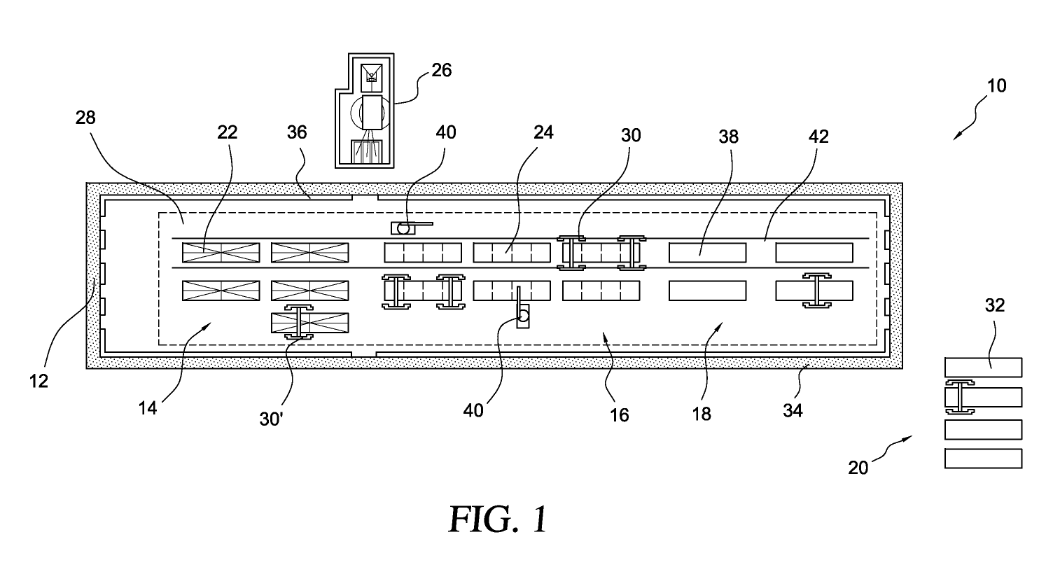

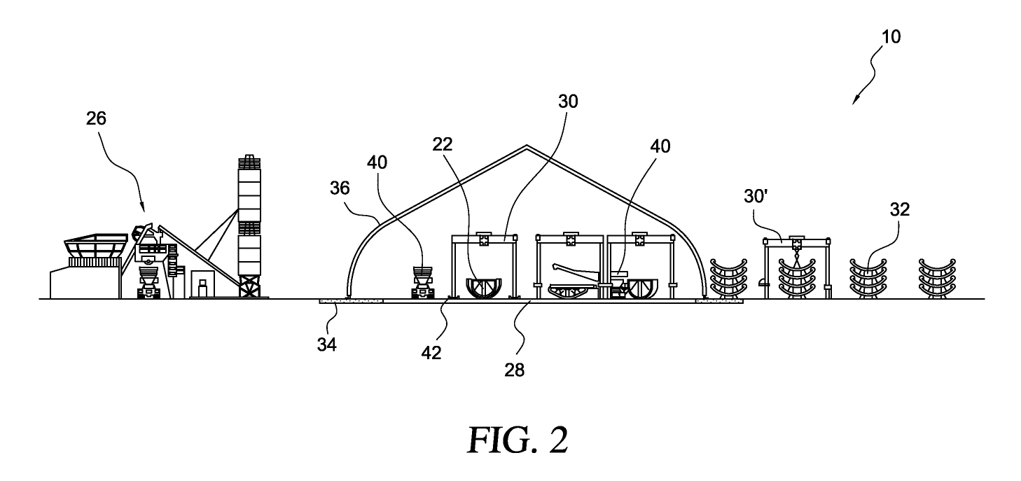

Referring to FIGS. 1 and 2, they show a first embodiment of a factory 10 for the molding manufacture of precast concrete voussoirs intended for the construction of wind generator support towers, according to the present invention, at a building site.

The factory 10 comprises at one end an entrance 12 for rebar-like elements, followed in an essentially linear manner in series by an reinforcing station 14, a concreting station 16, a conditioning station 18 and a stocking station 20.

In said reinforcing station 14, five frames 22 are arranged longitudinally in the direction of the production line, in two lines of two frames 22 and one line of one frame 22 parallel to one another. Said frames 22 receive rebar-like elements from said entrance 12. Said rebar-like elements are then attached to make cages. Said reinforcing station 14 can optionally comprise welding means for attaching the rebar-like elements to one another, although said cages will preferably be made by tying the rebar-like elements to one another in a manner that is known in the state of the art.

In said concreting station 16 six steam setting molds 24 are arranged longitudinally in the direction of the production line, in two lines of three molds 24 each. Said molds 24 are divided into four portions attached to one another by fixing means (not shown).

Said molds 24 receive the cages made in said reinforcing station 14, and concrete is subsequently poured into the molds 24, the poured concrete is left to set and the set parts 38 (in this case, semi-finished voussoirs intended for the construction of wind generator support towers) are finally extracted from said molds 24.

Optionally, corrugated sheaths intended to be embedded in a predetermined manner in the concrete once it is poured into said mold 24 will also be arranged in said reinforcing stations 14 or in said concreting station 16, such sheaths being suitable for a subsequent assembly of the voussoirs.

Optionally, in a manner known in the art said concreting station 16 can comprise pre-tensioned reinforcement pre-stressing means, including pre-stressing tendons, which are arranged in the mold and are tensioned before the pouring and setting of the concrete, and pre-stressing performance means, which will tension said pre-stressing tendons.

For the molding, each of said molds 24 includes a main mold body, a counter mold and a steam setting canvas (neither shown nor described in detail as it is part of the state of the art).

The concreting means comprise a concrete mixer 26 which, once assembled, is arranged in a stationary manner, laterally with respect to said concreting station 16 (said concrete mixer 26 could also be arranged in and be part of the actual concreting station 16). The concrete will therefore be poured into each mold 24 from said concrete mixer 26, in this embodiment by means of preferably self-propelled dispensing carriages 40 which are also part of said concreting means. As an alternative or as a complement to said dispensing carriages 40, tubular or semi-tubular conduits can be used (not shown in the figures).

Said conditioning station 18 is shown with four semi-finished voussoirs 38 which were brought from the concreting station 16, once extracted from said molds 24.

In said conditioning station 18, the semi-finished voussoirs 38 can receive a finishing (polishing and/or painting and/or lacquering, etc.). Furthermore, in said conditioning station 18, the semi-finished voussoirs 38 can be provided with the appropriate finishing accessories, for example with eye bolts or any other means of attachment to other voussoirs. The material necessary for the finishing enters said conditioning station 18 laterally with respect to said factory 10.

Said reinforcing station 14, said concreting station 16 and said conditioning station 18 make up the operational section of said factory 10. Said operational section 14, 16, 18 is established on a concrete slab 28 that is 20 cm thick.

Finally, said stocking station 20 has a plurality of finished voussoirs 32 stored in an orderly fashion, prepared for delivery.

The factory 10 includes hoisting means made up of two gantries 30 the rails 42 of which are fixed directly to said concrete slab 28 and of five self-propelled gantries 30′ on wheels.

Additionally, in the present embodiment, an asphalted area 34 is arranged laterally and contiguous to said operational section 14, 16, 18. The factory 10 further comprises a folding or modular canopy or stationary roof 36 extending above the entire operational section 14, 16, 18 and a portion of the asphalted area 34 to simply improve working conditions for the operators.

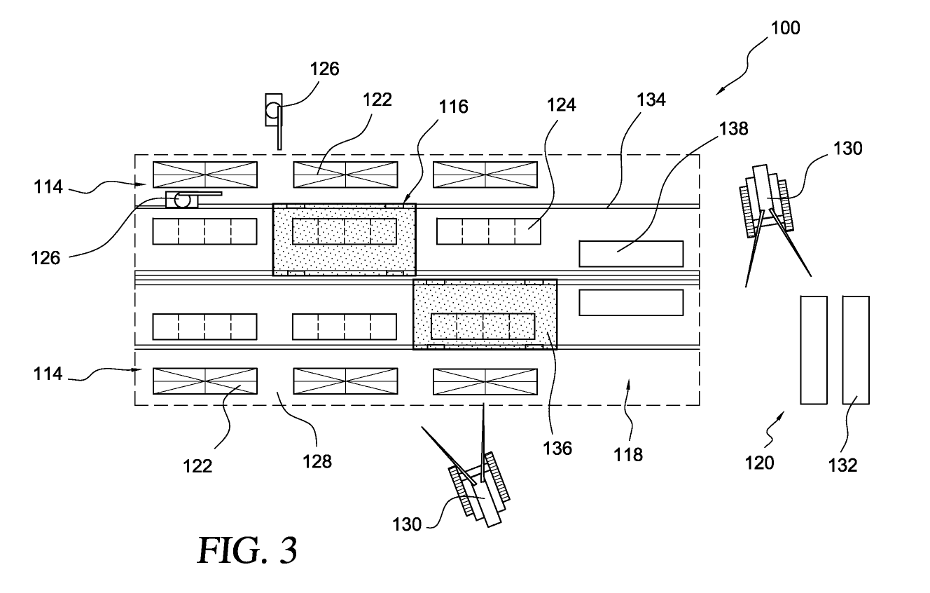

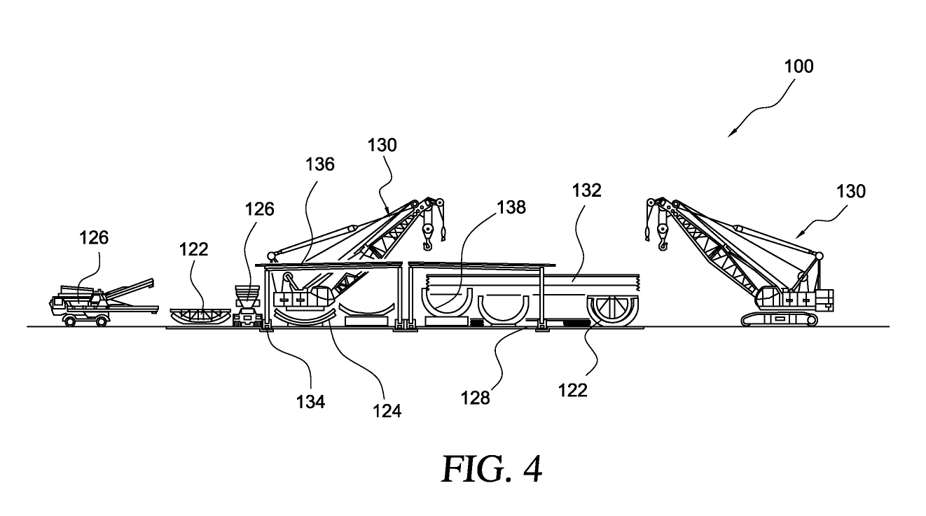

Now referring to FIGS. 3 and 4, they show a second embodiment of a factory 100 for the molding manufacture of precast concrete voussoirs intended for the construction of wind generator support towers, according to the present invention, at a building site.

The factory 100 comprises two reinforcing stations 114 and a concreting station 116, both elongated in the direction of the production line, parallel to one another, followed in an essentially linear manner in series by a conditioning station 118 and a stocking station 120.

In each of said reinforcing stations 114 three frames 122 are arranged longitudinally in the direction of the production line. Said frames 122 receive rebar-like elements laterally with respect to said factory 100. Said rebar-like elements are then attached to make cages. Optionally, as in the first embodiment discussed above, said reinforcing stations 114 can comprise welding means for attaching the rebar-like elements to one another, although said cages will preferably be made by tying the rebar-like elements to one another in a manner that is known in the state of the art.

In said concreting station 116 six steam setting molds 124 are arranged longitudinally in the direction of the production line, in two lines of three molds 124 each. Said molds 124 are divided into four portions attached to one another by fixing means (not shown).

Said molds 124 receive the cages made in said reinforcing station 114, and concrete is subsequently poured into the molds 124, the poured concrete is left to set and the set parts 138 (in this case, semi-finished voussoirs intended for the construction of wind generator support towers) are finally extracted from said molds 124.

For the molding, each of said molds 124 includes a main mold body, a counter mold and a steam setting canvas (neither shown nor described in detail as it is part of the state of the art).

As can be seen in FIGS. 3 and 4, in this embodiment said reinforcing stations 114 are parallel with said concreting station 116 such that said concreting station 116 is located between said reinforcing stations 114.

This factory 100 comprises completely moveable concreting means specifically consisting of two concrete mixer trucks 126 moving laterally with respect to said reinforcing stations 114. The concrete will then be poured directly from said concrete mixer trucks 126 into each mold 124.

Optionally, corrugated sheaths intended for being embedded in a predetermined manner in the concrete once it is poured into said mold 124 will also be arranged in said reinforcing stations 114 or in said concreting station 116, such sheaths being suitable for a subsequent assembly of the voussoirs.

Optionally, in a manner known in the art said reinforcing stations 114 or said concreting station 116 can comprise pre-tensioned reinforcement pre-stressing means, including sheathed pre-stressing tendons, which are arranged in the mold before the pouring and setting of the concrete and will be tensioned after the pouring and setting of the concrete, and pre-stressing performance means, which will tension said pre-stressing tendons.

Said conditioning station 118 is shown with two semi-finished voussoirs 138 which were brought from the concreting station 116 once extracted from said molds 124.

In said conditioning station 118, the semi-finished voussoirs 138 can receive a finishing (polishing and/or painting and/or lacquering, etc.). Furthermore, in said conditioning station 118, the semi-finished voussoirs 138 can be provided with the appropriate finishing accessories, for example with eye bolts or any other means of attachment to other voussoirs. The material necessary for the finishing enters said conditioning station 118 laterally with respect to said factory 100.

As an alternative to what has been described above, said pre-stressing performance means will preferably be arranged in said conditioning station 118.

Said reinforcing station 114, said concreting station 116 and said conditioning station 118 make up the operational section of said factory 100. Said operational section 114, 116, 118 is established on a concrete slab 128 that is 20 cm thick.

Finally, said stocking station 120 has a plurality of finished voussoirs 132 stored in an orderly fashion, prepared for delivery and subsequent assembly.

The factory 100 includes hoisting means made up of two boom crane trucks 130 moving laterally with respect to said operational section 114, 116, 118.

Additionally, in the present embodiment, the factory 100 comprises two moveable roofs 136 to simply improve the working conditions for the operators. Said moveable roofs 136 slide in the direction of the production line in respective straight contiguous parallel paths of said operational section 114, 116, 118, on rails 134 formed directly in said concrete slab 128. In the present embodiment, each moveable roof 136 has an extension in the direction of said rails 134 essentially equal to the length of a mold 124.

Naturally, the principle of the invention remaining the same, the embodiment details can be greatly varied with respect to those described and illustrated herein simply by way of non-limiting example, without thereby departing from the scope of protection defined by the attached claims.

Basically, the reinforcing station(s), the concreting station(s), the conditioning station(s) and the stocking station(s) will be arranged in any direction and relative position, preferably such that the contour of the factory adapts to the available surface at the building site. Likewise, the frames in the reinforcing station(s), the molds in the concreting station(s), the semi-finished voussoirs in the conditioning station(s) and the finished voussoirs in the stocking station(s) will be arranged in any number, direction and position, preferably such that the contour of the factory adapts to the available surface at the building site. Furthermore, the frames in the reinforcing station(s) and the molds in the concreting station(s) will have the dimensions (width, length, curve, etc.) suited to the manufacture to be obtained. All this is obviously done such that the predetermined yield requirements are met.

Likewise, if the factory comprises one or more roofs, whether they are stationary or moveable, they can be sized and arranged in any manner suited to the configuration of the factory.

Of course two or more factories according to the present invention can be paired or matched up to form a single manufacturing unit without thereby departing from the scope of the invention.

Furthermore, the supplies such as the rebar-like elements and the conditioning material can enter the factory in the manner that is likewise most suited to the configuration of the factory. For example, in the case mentioned above of a manufacturing unit formed by several factories according to the invention matched up to one another, it may be appropriate for most of the supplies to enter through entrances located at the beginning and at the end of the production lines if the factories are basically elongated in the direction of the production lines.

Finally, it must be understood that as it is used herein the term “rebar-like element” is intended to mean any solid reinforcing steel-type body, reinforcement, reinforcing steel, smooth bar, corrugated bar, steel cord, strand, etc. used in the art such that it is embedded in the concrete part to give improved properties to the part against tensile stresses.

The present invention has been described in the context of a number of embodiments and examples thereof. It is to be understood, however, that other expedients known to those skilled in the art or disclosed herein may be employed without departing from the spirit of the invention.

Therefore, it is intended that the appended claims be interpreted as including the embodiments described herein, the alternatives mentioned above, and all equivalents thereto.

What is claimed is:

1. A factory for the molding manufacture of precast concrete voussoirs for the construction of wind generator support towers, using passive steel or rebar-like element(s), as well as active pre-stressing steel, with or without sheath, concrete and finishing accessories, the factory including hoisting means and concreting means, the factory comprising:
at least one reinforcing station, with at least one frame, for preparing cages,
at least one concreting station , with at least one steam setting mold including a main mold body, a counter mold and a steam setting canvas, for the application of one of said cages in said mold , the concreting of said mold , the setting of said concrete in said mold and the extraction of the set part (semi-finished voussoir) from said mold,
at least one conditioning station for the finishing of said semi-finished voussoir and/or the application of finishing accessories to said semi-finished voussoir , and
at least one stocking area for the storage of finished voussoirs;
wherein the base of said reinforcing station , said concreting station and said conditioning station comprises a concrete slab formed directly on compacted terrain, i.e., without foundations, anchors or the like to the compacted terrain, in that said hoisting means are hoisting means without foundations, in that said mold body is divided into at least two portions attached to one another by fixing means, and in that said counter mold is divided into at least two portions attached to one another by fixing means.

2. The factory according to claim 1, further comprising pre-stressing means, including pre-stressing performance means and pre-stressing tendons.

3. The factory according to claim 2, wherein said pre-stressing performance means are arranged in said concreting station in the case of pre-tensioned reinforcement or in said conditioning station in the case of post-tensioned reinforcement.

4. The factory according to claim 1, wherein all or a portion of said hoisting means without foundations are moveable and/or all or a portion of said concreting means are moveable.

5. The factory according to claim 4, wherein said hoisting means comprise one or more boom crane trucks and/or one or more gantries on rails and/or one or more gantries on wheels.

6. The factory according to claim 5, wherein at least one of said gantries on rails and/or at least one of said gantries on wheels are self-propelled.

7. The factory according to claim 4, wherein said concreting means comprise one or more concrete mixer trucks or pieces of concrete distributing equipment, including pumping equipment.

8. The factory according to claim 1, wherein said concrete slab is formed on site in a single part.

9. The factory according to claim 1, wherein said concrete slab preferably has a thickness of 15 cm at the least and preferably 25 cm at the most.

10. The factory according to claim 1, further comprising at least one folding or modular canopy or stationary roof at least partially covering said reinforcing station and/or said concreting station and/or said conditioning station .

11. The factory according to claim 1, further comprising at least one moveable roof at least partially covering said reinforcing station , said concreting station and said conditioning station.

12. The factory according to claim 11, wherein said moveable roof slides in the direction of the production line on rails formed directly in said concrete slab and has an extension in the direction of said rails essentially equal to the length of a mold.

13. An operating method of a factory for the molding manufacture of precast concrete voussoirs intended for the construction of wind generator support towers according to any one of the previous claims, characterized in that it includes the following steps:
placing the factory in a place of origin in a disassembled state in initial units that are smaller than the voussoirs to be manufactured,
taking said initial units to a building site close to the point of delivery of the voussoirs to be manufactured,
assembling the factory at said building site starting from said initial units,
manufacturing the pertinent voussoirs by means of the factory in the assembled state,
disassembling the factory at said building site until the factory is in a disassembled state in final units that are smaller than the manufactured voussoirs, and
taking said final units to a place of destination leaving said building site in basically the same conditions as before assembling the factory at said building site.

14. The method according to claim 13, wherein said place of destination is said place of origin.

15. The method according to claim 13, wherein said place of destination is another building site.
